(19) United States
(12) Patent Application Publication
(10) Pub. No.: US 2005/0209917 A1
(43) Pub. Date: Sep. 22, 2005

(54) Employee incentive program

(76) Inventors: Brian Anderson, Aptos, CA (US); Brian Emerson, Brookdale, CA (US); Jack Daley, Stamford, CT (US); Berry Crawford, Oakland, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/803,849

(22) Filed: Mar. 17, 2004

(51) Int. Cl. G06F 17/60; G06F 7/08

(52) U.S. Cl. 705/14

(57) ABSTRACT

An employee incentive program is disclosed. According to an embodiment, an employee account is credited with a first amount when a new customer account is opened. The employee account is also credited when an existing customer account is used. In a further embodiment, the employee account is credited with a third amount when an account opened by the employee is used.

### FIELD OF THE INVENTION

The present invention is related to sales promotions and more specifically to employee incentive programs.

### BACKGROUND

A customer incentive program can be used to increase sales at a retail establishment. Customer incentive programs typically reward customers for continued patronage of a particular retail store, subset of retail stores, product, etc. By offering rewards to a customer, the customer is more likely to shop at a specific retailer or buy certain goods.

Some customer incentive programs allow customers to accumulate “points” for each purchase. A customer is assigned an account in which the points are deposited. These points may be equal to a percentage of the total purchase price of a specific item or a total purchase. At the time of purchase, a customer presents an account card bearing a customer's account number, a payment vehicle with the customer's account number either imbedded or linked to the payment vehicle, a phone number, etc. to a cashier. The account card, etc. is linked to the customer's account, and the resulting points are deposited in the customer's account. These points may then be exchanged at a later time for something of value. For example, an incentive program card may be issued to a customer. The customer can then use the card when making a retail purchase, and have a certain value added to his account a result of the purchase. For example, the customer incentive program may offer five percent of the value of the customer's purchase in reward points. At a later time, the customer may redeem these points for merchandise, a cash rebate, a charitable donation, etc.

The customer incentive program operator typically has an agreement with a retailer, a product manufacturer, etc. under which the operator receives a percentage of the purchase price from the retailer. A customer may also establish a relationship with a charitable or other association through which accumulated points are donated to the association. For example, the program operator may receive five percent of a given retail purchase value from the retailer when the program card is used by the customer. The five percent of the retail value received by the program operator may be partly applied to the customer's account, and partly retained as profit by the program operator. As a result, the success of the incentive program relies on the frequent use of the program cards by customers. Customers may often forget about the incentive program and forget to use their cards when they are making purchases. It is suggested that having a full time employee who reminds customers at the check out line to use their program incentive card can increase program revenues by as much as five times. However, it is inefficient to have full time employees dedicated to encouraging customers to use their program and incentive cards. As a result, what is needed is a way to encourage use of the program to increase program revenues.

There tends to be high employee turnover at retail stores for a variety of reasons. Hiring new employees is expensive, because of various costs including recruiting and training costs. Therefore, it is desirable for retailers to improve employee retention to reduce costs. Further, experienced employees tend to know the practices and procedures of a particular retail establishment well as a result of having been employed there for a long time. Experienced employees also tend to enthusiastic about their work and their work place, which leads to better sales. Therefore, what is also needed is a method for promoting employee retention.

### SUMMARY OF THE INVENTION

According to an embodiment of the invention, a method for implementing an employee loyalty program is disclosed. According to this method, an employee account is credited with a first amount in response to the creation of a new customer account, and credited with a second amount in response to the use of an existing account. According to a further embodiment, the employee account is credited with a third amount when the new account is used again, and so on.

### BRIEF DESCRIPTION OF THE DRAWINGS

FIG. 1 illustrates an example of a customer enrollment form.

FIG. 2 illustrates an employee enrollment form for enrollment in the employee incentive program.

FIG. 3 illustrates a network to record transactions required by the program.

FIG. 4 illustrates the distribution of the purchase price of a retail item.

FIG. 5 illustrates a flowchart for implementing embodiments of the invention.

### DETAILED DESCRIPTION

Described herein is an employee incentive program. In the following description numerous specific details are set forth. However, it is understood that embodiments may be practiced without these specific details. For example, well known equivalent processes or equipment may be substituted in place of those described herein. In other instances, well known structures and techniques are not shown in detail in order to not obscure the understanding of this description.

According to an embodiment of an invention, an employee incentive program is established in conjunction with a customer incentive program. Each employee enrolled in the employee incentive program has an account which may accumulate credits or value when a customer makes a purchase using a customer incentive program account. In one embodiment, for example, a customer incentive account may accumulate credits corresponding to a percentage of each purchase which may be later redeemed for savings bonds. An employee enrolled in the employee incentive program may also have a similar account, which accumulates value whenever a customer makes a purchase with a customer account that may also be later exchanged for savings bonds. In other embodiments, the value of the account may be exchanged for retail merchandise, services, charitable donations, etc.

An employee at a retail establishment may have a customer incentive account established with a program operator, and may accumulate credit by purchasing retail goods using a customer incentive program card issued to the employee. That same account may also accumulate credit when the employee encourages use of the customer incentive card at the retail establishment where they work. The employee account may be credited when a new customer account is established or when an existing customer account is used. This encourages the use of the customer incentive card, and the expansion of the program. If the employee is given an incentive to encourage new customer enrollment and to encourage use of existing customer accounts the program will be more successful.

In one embodiment, a first value is awarded to the employee account for establishing a new customer account and a second value is awarded to the employee for using an existing customer account. In another embodiment, the first value is greater than the second value. In a further embodiment, the employee receives credit each time an account that was opened by the employee is used.

The employee incentive program helps to increase penetration of the customer incentive program by encouraging employees to enroll new customers in the customer incentive program. Further, the employee incentive program also improves transactions involving the customer incentive program. Customers often forget to use their customer incentive program cards or corresponding linked payment vehicles (e.g., phone number, member Identification (ID) number), and as a result, much potential revenue to the customer incentive program is lost. By giving incentives to employees, this revenue can be realized.

The employee incentive program can also be marketed to employers as an employee retention program. According to an embodiment, an employee will lose their account balance as soon as they leave their employer. This will encourage employees to continue their employment in order to retain the credits they have accumulated in their employee account.

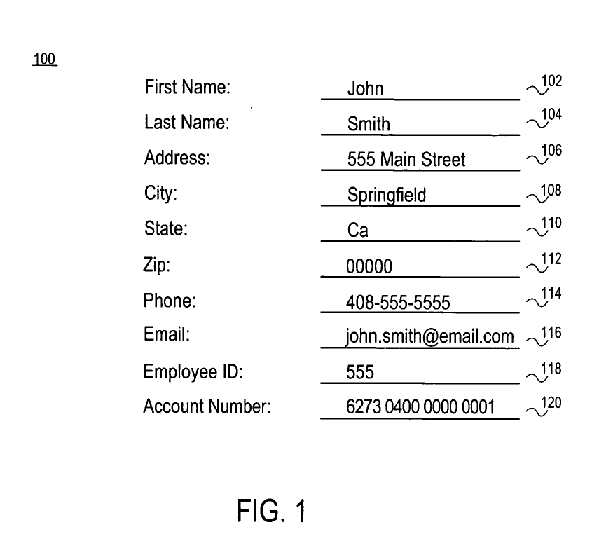

FIG. 1 illustrates an example of a customer enrollment form. The customer enrollment form 100 can be used at a retail location to enroll a customer in the customer incentive program. In order to enroll a customer in the customer incentive program, several pieces of data may be required. The required data may vary based on the needs of the program, and the form 100 is an example of what types of demographic data may be required.

The enrollment form 100 may include a field for the customer's first name 102, the customer's last name 104, the customer's address 106, and the customer's city 108, the customer's state 110, customer's zip code 112, and the customer's phone number 114. These data are used to administer the customer incentive program. These data may be necessary to contact the customer, to send the customer information about the program, to send the customer the completed rewards once they have been earned.

In field 116, a customer's email address may be entered. The email address can be used to send the customer promotional information, or to allow the customer to access a world wide web (www) site which may have information about the customer's account, including balance, rewards earned, etc. A customer may also enroll in the customer incentive program using a website established by the customer incentive program operator. Customers may find this more convenient as well as more reliable and less prone to error. If a customer is enrolling in the customer incentive program at a retail store, the form may also include field 118 to input an employee's ID number. Employees at retail establishments usually have identification numbers (ID) which are used to enable payroll and other administrative functions at the store. This ID number can be entered on the enrollment form 100 in order to track the sign up of a new customer program and credit and employee's employee incentive account for the new customer enrollment.

The customer enrollment form 100 may also have a preprinted account number 120 on the enrollment form. A program card may be attached to the enrollment form also having the preprinted account number 120 on it. The account number 120 is used to track the customer's usage of the program card and also to credit the appropriate account when credit is due. After the customer has completed the enrollment form 100, the employee may collect the enrollment form 100 to return it to the program operator or the customer may mail the enrollment form to the program operator if the customer wishes to fill out the form at a later time.

It is understood that there are several variations of the form 100 that may also be used. For example, more or fewer data fields may be included, depending on the needs of the customer incentive program. The form 100 is given as an example.

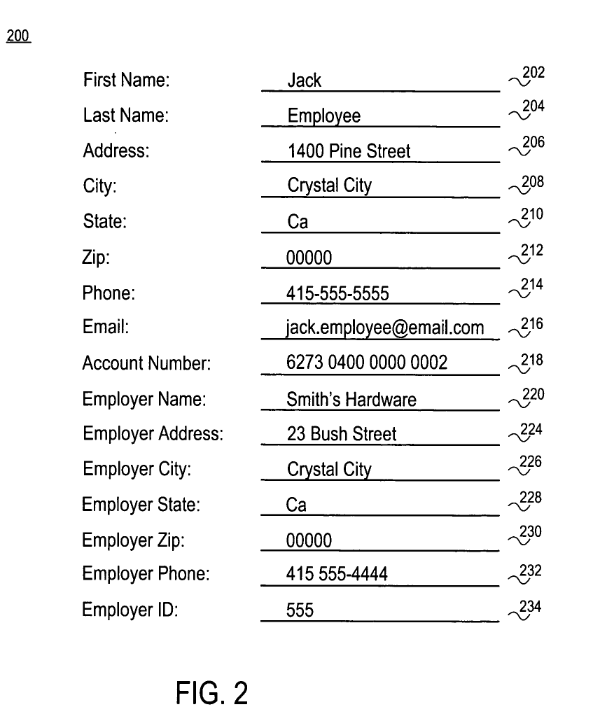

FIG. 2 illustrates an employee enrollment form for enrollment in the employee incentive program. The form 200 includes several fields, including field for the employee's first name 202, a field for the employee's last name 204, a field for the employee's address 206, a field for the employee's city 208, a field for the employee's state 210, a field for the employee's zip code 212, and a field for the employee's phone number 214. This demographic data from the employee can be used to establish an employee incentive account similar to the customer incentive account established for a customer. The employee can receive credits the same way the customers receive credits for their account. The employee may also enter an email address 216 to receive updates from program and to access the program website.

In the field 218, the employee may enter an account number, if the employee is already a member of the program as a customer. Instead of establishing a new account for the employee, the program operator can reference the employee's existing account to the employee's employee identification number by the account number 218 so that credits from the employees incentive program can be added to the employee's existing account.

Demographic information about the employer, i.e., the retail store, may also be collected. In the field 220, the employer name is entered, and in the field 224 the employer's address is entered, in the field 226 the employer's city is entered, in the field 228 the employer's state is entered, in the field 230 the employer's zip code is entered, and in field 232 the employer's phone number is entered. In the field 234 the employee ID number is entered. As mentioned above, the employee ID number can be used to track the employee and can be linked to the employee's employee incentive account in order to allow for simplified crediting of the employee's account in the program.

It is understood that there are several variations of the form 200 that may also be used. For example, more or fewer data fields may be included, depending on the needs of the employee incentive program. The form 200 is given as an example.

It is understood that other methods and manners for enrolling customers and employees in the various programs may be used. For example, a customer may enroll on the program operator's website. An employer may also be enrolled by their employer which can save administrative costs over using individual enrollment forms for each employee. An employer may want to enroll all their employees in the employee incentive program in order to promote employee satisfaction and retention. The program can provide a secondary income source for the employees enrolled in it, and therefore the employer can promote the program at little additional cost.

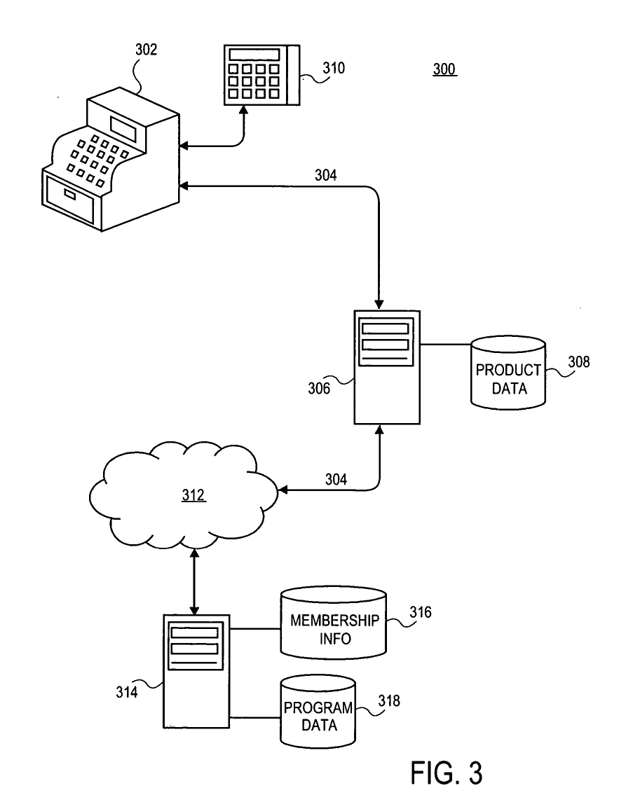

FIG. 3 illustrates a network to record transactions required by the program. An incentive program operator may either operate the network themselves or have a third party track the program transactions. When a customer is being received by a cashier at a store using the program, the cashier can first ask whether or not the customer is a member of the customer incentive program. If the costumer replies that they are not a member of the program, the employee can ask whether the customer would like to join the program. If the customer agrees to join a program, the customer can enroll in the program using an enrollment form such as the form in FIG. 1. If the customer is already enrolled in the program, the employee may ask the customer whether or not the customer wishes to use their program card. By asking these questions, the employee is promoting use of the program and enrollment in the program. It has been shown that customers typically forget to use their card even if they are enrolled in the program and, by offering incentive to employees for reminding customers to use their card and to encourage customers enroll in the customer incentive program, program penetration can dramatically increase.

When a customer purchases an item, a cashier typically completes the sale at a Point of Sale (POS) terminal such as a cash register 302. The cash register 302 can be used to scan the item, determine the price of the item, and complete the sale. The cash register 302 is connected over a Local Area Network (LAN) 304 to a server 306 that is coupled to a data volume 308. The data volume 308 stores information about the store's inventory, such as the prices of items, as well as employee information.

The cash register 302 can read a customer's card. Alternatively, the customer can run their card through a terminal 310, such as a terminal typically used for debit and other payments. Once the customer's account number has been obtained from the customer's card, the information, in conjunction with the employee's ID number, can be transmitted over the LAN 304, and over a Wide Area Network (WAN) 312, such as the Internet, to a server 314. The server 314 may be operated by the program operator or a third party, and is coupled to several data volumes, including volumes 316 and 318, which store membership information and program data, respectively. The volume 316 contains information relating to membership accounts in the program, as well as account balances, etc.

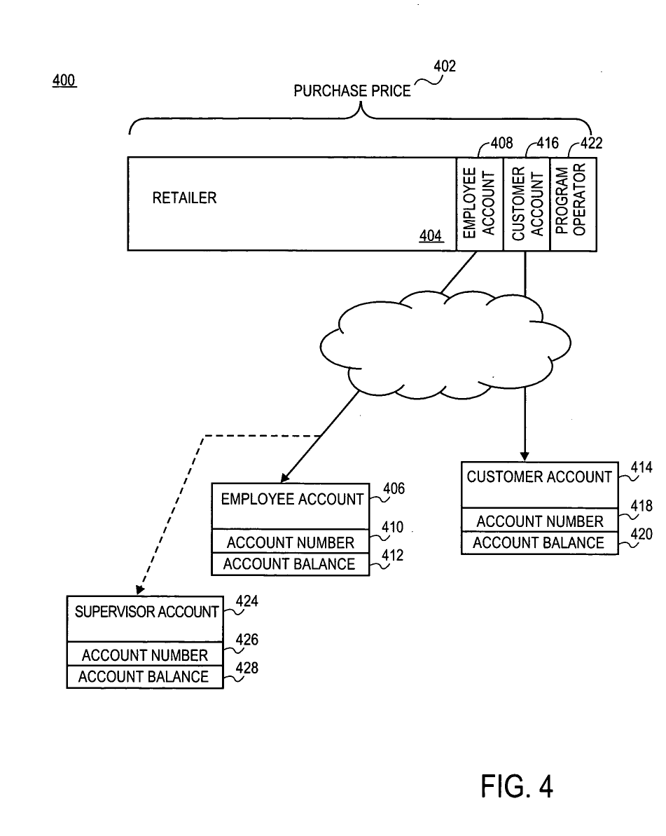

FIG. 4 illustrates the distribution of the purchase price of a retail item. A retailer typically has established an agreement with the program operator to return a portion of the price of the retail item to the program operator. The purchase price 402 represents the entire price of the item. The retailer will generally receive the largest portion of the purchase price 404. For example, a retailer may have an agreement with the program operator that the retailer will return 3% of the purchase price to the program operator. In this scenario, the retailer would retain 97% of the purchase price 404.

The remaining 3% is used by the program operator to fund the program and to realize a profit. For example, as a reward for encouraging the use of the program card, an employee account 406 may receive 1% 408 of the purchase price of the item. The employee account 406 will include an account number 410, and a running account balance 412. The employee account 406 may be stored on a volume such as the volume 316. The 1% 408 of the purchase price will be applied to the account balance 412 upon the sale of the item.

The customer account 414 will also receive a portion 416, which is, for example, 1% of the purchase price. The customer account includes the account number 418 and the account balance 420. The customer will receive their typical percentage as outline in the program. The program operator will also receive a percentage 422, for example, 1%. The program operator's percentage 422 helps administrate the program and ensures profits.

In an alternate embodiment, an employee's supervisor may also receive a portion of the employee's percentage 408 for each transaction. In this way, the employee's supervisor is given an incentive to ensure that the employees under their supervision are implementing the program. The supervisor's account 424 may also receive a percentage. The supervisor's account has an account number 426 and an account balance 428. In another embodiment, the supervisor can receive incentives based on the total usage of the program, rather than a percentage of each transaction. For example, if total transactions eclipse a predetermined barrier, the supervisor may receive a reward such as a vacation package.

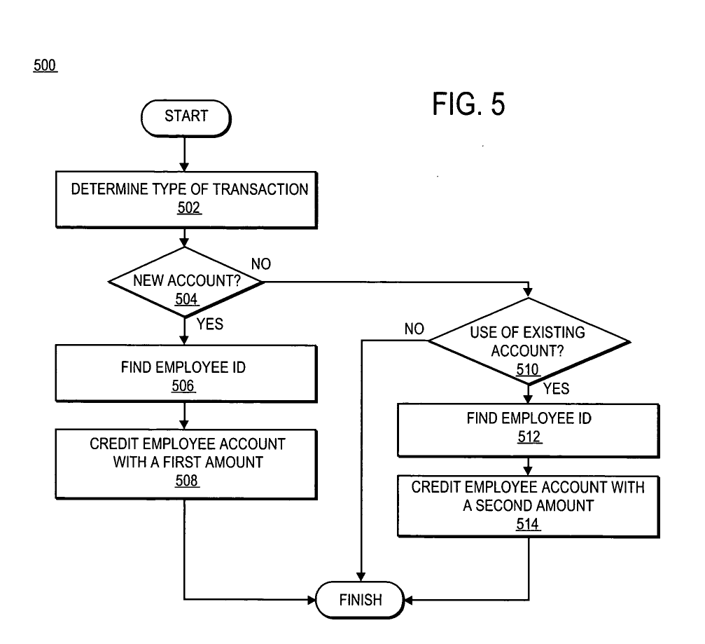

FIG. 5 illustrates a flowchart for implementing embodiments of the invention. The process 500 describes how an employee account is credited when a customer makes a purchase using the program card. As mentioned above, the employee is credited for both creating a new account, and using an existing account. By giving an employee credit each time an account is used, the employee is more likely to encourage use of the program card, and as a result, the program will be more successful.

When the purchase is being made, the employee asks whether the customer has a program card, and if they do, whether they want to use it. If the customer does not have a program card, the employee can encourage the customer to enroll. Once an item has been purchased and a program card has been read, the type of transaction is determined in block 502. In block 504, if the transaction is the opening of a new account, the process 500 proceeds to block 506. In block 506, the employee ID is retrieved from the POS terminal. In block 508, the employee ID is used to locate the employee's account, and the account is credited with a first amount. The first amount depends on the price of the item being sold.

If the transaction is not the opening of a new account, in block 510 it is determined whether the transaction is the use of an existing account. If it is, in block 512 the employee ID is retrieved, and in block 514, the employee account is credited with a second amount.

In one embodiment, the first amount is greater than the second amount, in order to emphasize the relative importance of establishing new accounts relative to using old accounts. However, it is understood that any relative value may be assigned to the opening of accounts and the use of existing accounts.

In another embodiment, an employee may be credited with a third amount whenever an account that the employee opened is later used. This can improve employee retention, since the employee will continue to receive bonuses for the use of all of the accounts that they have created as long as they remain with their employer.

The employee's account balance can be applied toward many different rewards. For example, in one embodiment, an employee receives their account balance in U.S. Savings Bonds. Since a U.S. Savings Bond can be purchased for much less than its face value, the employee is given the perception that they are receiving something of a much greater value than its actual cost. In another embodiment, an employee can designate that the proceeds of their account will be donated to charitable organizations.

In a further embodiment, the value of the employee account can be applied toward the purchase of retail goods, including items such as gift certificates, gift cards, vacation packages, etc. In this embodiment, the program operator can use a fulfillment house to supply the goods to the employee. Offering retail goods has the advantage of returning funds to the employee incentive program. Further, since the goods are typically available from a fulfillment house for much less than their perceived value, the program operator can offer something of a greater perceived value than cost.

This invention has been described with reference to specific exemplary embodiments thereof. It will, however, be evident to persons having the benefit of this disclosure that various modifications and changes may be made to these embodiments without departing from the broader scope and spirit of the invention. The specification and drawings are accordingly to be regarded in an illustrative rather than in a restrictive sense.

1. An method for implementing an employee loyalty program comprising:
crediting an employee account with a first amount in response to the creation of a new customer account; and
crediting the employee account with a second amount in response to the use of an existing customer account.

2. The method of claim 1, wherein the first amount is greater than the second amount.

3. The method of claim 1, further comprising:
crediting the employee account with a third amount when the new customer account is used again.

4. The method of claim 1, wherein the employee account is redeemable for savings bonds.

5. The method of claim 1, wherein the employee account may be applied toward charitable donations.

6. The method of claim 1, wherein the employee account is redeemable for retail goods.

7. The method of claim 1, wherein the employee account is tracked according to an employee identification number.

8. The method of claim 1, wherein the employee account belongs to a retail employee.

9. The method of claim 8, further comprising:
crediting a supervisor account belonging to a supervisor of the employee when crediting the employee account.

10. A method for implementing an employee loyalty program comprising:
establishing an employee account linked with an employee identification number (ID);
determining the employee ID in response to a customer transaction;
determining a transaction type in response to the customer transaction;
crediting the employee account with a first amount if the customer transaction is of a first type; and
crediting the employee account with a second amount if the customer transaction is of a second type.

11. The method of claim 10, wherein determining the employee ID further comprises retrieving the employee ID from a Point of Sale (POS) terminal.

12. The method of claim 10, wherein the first type is creating a new account.

13. The method of claim 12, wherein the second type is using an existing account.

14. The method of claim 10, wherein the employee account may be redeemed for savings bonds.

15. The method of claim 10, wherein the employee account may be applied toward charitable donations.

16. The method of claim 10, wherein the employee account may be redeemed for retail goods.

17. The method of claim 16, wherein the retail goods are chosen from a group including a gift certificate, a gift card, and a vacation package.

18. A machine readable medium having stored thereon executable program code which, when executed, causes a machine to perform a method for implementing an employee loyalty program, the method comprising:
crediting an employee account with a first amount in response to the creation of a new customer account; and
crediting the employee account with a second amount in response to the use of an existing customer account.

19. The machine readable medium of claim 18, wherein the first amount is greater than the second amount.

20. The machine readable medium of claim 18, the method further comprising:
crediting the employee account with a third amount when the new customer account is used again.

21. The machine readable medium of claim 18, wherein the employee account is redeemable for savings bonds.

22. The machine readable medium of claim 18, wherein the employee account may be applied toward charitable donations.

23. The machine readable medium of claim 18, wherein the employee account is redeemable for retail goods.

24. The machine readable medium of claim 18, wherein the employee account is tracked according to an employee identification number.

25. The machine readable medium of claim 18, wherein the employee account belongs to a retail employee.
